(19) United States
(12) Patent Application Publication
(10) Pub. No.: US 2008/0262127 A1
(43) Pub. Date: Oct. 23, 2008

(54) FLAME RESISTANT RESIN COMPOSITION

(75) Inventors: Kuen-Yuan Hwang, Taipei (TW); An-Pang Tu, Taipei (TW); Gai-Chi Chen, Taipei (TW); I-Cheng Hsu, Taipei (TW)

Correspondence Address: MORRISON & FOERSTER LLP, 755 PAGE MILL RD, PALO ALTO, CA, 94304-1018, US

(73) Assignee: Chang Chun Plastics Co., Ltd., Taipei (TW)

(21) Appl. No.: 12/018,099

(22) Filed: Jan. 22, 2008

(30) Foreign Application Priority Data
Apr. 23, 2007 (TW) 096114194

(51) Int. Cl. C08K 3/00; C08K 3/20; C08K 3/26

(52) U.S. Cl. 523/400; 524/611; 524/592; 524/609; 524/425; 524/430; 524/451

(57) ABSTRACT

A flame resistant resin composition is provided, which includes: (A) at least an epoxy resin having a biphenylic unit or a naphthalenic unit; (B) phenolic resins used as a curing agent, the phenolic resins include at least a phenolic resin having a biphenylic moiety and a polyphenolic moiety, wherein the the at least a phenolic resin having a biphenylic moiety and a polyphenolic moiety is in an amount of 30 to 100 wt % of the total weight of the curing agents; (C) a curing-promoting agent; and (D) an inorganic filler material. The resin composition includes an epoxy resin having a biphenylic unit or a naphthalenic unit and the phenolic resin having a biphenylic moiety and a polyphenolic moiety as a curing agent, such that excellent flame resistance can be achieved without adding flame resistant agents. The resin composition also has a higher glass transition temperature to improve the water absorption issue after curing, and increases heat stability. Therefore, the resin composition is particularly useful in composite materials, forming materials or semiconductor packaging materials.

### CROSS-REFERENCE TO RELATED APPLICATIONS

This application claims the benefit of Taiwan application no. 096114194, filed Apr. 23, 2007, the disclosure of which is incorporated herein by reference in its entirety.

### BACKGROUND OF THE INVENTION

1. Field of Invention

The present invention relates to flame resistant resin compositions, and more particularly, to a flame resistant epoxy resin composition.

2. Description of Related Art

With easy workability, ensured safety, and excellent mechanical and chemical properties, epoxy resins are widely used in a number of applications such as manufacturing of composite materials, or used as forming materials or semiconductor packaging materials. To improve the flame resistant property of epoxy resins, halogen-containing epoxy resins or curing agents are often used in conjunction with antimony trioxide or other flame resistant agents to meet the UL 94V-0 standard.

However, antimony trioxide is reported as a carcinogenic substance. Moreover, during ignition, aromatic compounds with high bromide contents generate highly toxic brominated furans and brominated dioxins, in addition to corrosive bromide free radicals and hydrogen bromide from bromide. The free radicals and the compounds can adversely affect human health and environment. Therefore, a variety of flame resistant epoxy resin compositions without halogen, for example, hydroxides (such as aluminum hydroxide or magnesium hydroxide) or phosphate-containing flame resistant agents, have been developed. However, a large amount of hydroxides are needed in order to provide desired flame resistance. This often causes an increase in viscosities of resin compositions, which adversely affects molding. On the contrary, phosphate-containing flame resistant agents can easily hydrolyze to generate phosphoric acid, which causes corrosion and affects the reliability of final products.

As environmental concern increases, developed countries have banned the use of highly contaminant materials one after another. As for related fields of the semiconductor packaging technology, developments of solder materials gradually focus on lead-free solder materials. To respond to such a change in the development of solder materials, a higher temperature condition must be applied in the reflowing process during encapsulation of semiconductors. In this case, the epoxy resin compositions used in encapsulation of semiconductors must be flame resistant and heat-stable.

U.S. Pat. No. 6,242,110 discloses an epoxy resin composition for encapsulating a semiconductor. The epoxy resin composition may include a phenolic resin having a biphenylic moiety and a monophenolic moiety and an epoxy resin having a biphenyl or a naphthalene unit. The epoxy resin composition can be used to meet the UL 94V-0 standard without adding flame resistant agents. The patent neither teaches nor suggests the use of phenolic resins having a biphenylic moiety and a polyphenolic moiety as a curing agent, or the impact of the resin composition on the heat stability.

On the contrary, U.S. Pat. No. 6,894,091 discloses a semiconductor encapsulating epoxy resin composition, comprising an epoxy resin, a phenolic resin curing agent, a molybdenum compound, and an inorganic filler. The uses the molybdenum compound is used as a flame resistant agent, and the epoxy resin and/or the phenolic resin contain nitride in an amount of 1.5 wt % to 20 wt % of the total weight of the epoxy resin and the phenolic resin, so as to achieve desired flame resistance. However, the U.S. Pat. No. 6,894,091 neither teaches nor suggests the use of phenolic resins having a biphenylic moiety and a polyphenolic moiety as a curing agent, or the impact of the resin composition on the glass transition temperature.

### SUMMARY OF THE INVENTION

It is therefore an objective of the invention to provide a resin composition with excellent flame resistance without the need of additional flame resistant ingredients.

It is another objective of the invention to provide a resin composition with a high glass transition temperature.

It is still another objective of the invention to provide a resin composition with high heat stability.

In order to attain the above and other objectives, the invention provides a flame resistant resin composition, which comprises: (A) at least an epoxy resin having a biphenylic unit or naphthalenic unit; (B) phenolic resins used as curing agents, and comprising at least a phenolic resin having a biphenylic moiety and a polyphenolic moiety, wherein the phenolic resin having a biphenylic moiety and a polyphenolic moiety is in an amount of 30 to 100 wt % of the total weight of the phenolic resins; (C) a curing-promoting agent; and (D) an inorganic filler material.

In a preferred embodiment of the invention, the number ratio (C/O) of carbon (C) atoms to oxygen (O) atoms in the biphenylic and polyphenolic moieties of the phenolic resin is smaller than (26+20n)/(n+2). In another preferred embodiment of the invention, the phenolic resin having the biphenylic and the polyphenolic moieties has the structure represented by formula (I):

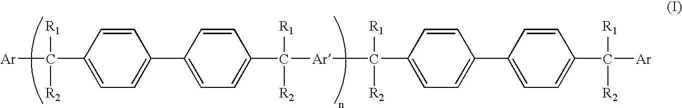

wherein,

R₁ and R₂ are the same or different, and R₁ and R₂ are independently hydrogen or a C₁-C₆ alkyl group; n is 0 or an integer of 1 to 10;

Ar is a selected from the following monovalent groups (i) to (iii):

(i) a monocyclic ring having at least two phenolic hydroxyl groups and a fused C₆-C₁₈ polycyclic aryl group;

(ii) a monovalent group having at least two phenolic hydroxyl groups and formed by two phenyl groups or naphthyl groups via chemical bonding or a linkage group, wherein the linkage group is selected from an optionally substituted C₁-C₆ alkylene, an optionally substituted C₁-C₆ cyclic alkylene, —O—, —S—, —S—S—, —C(═O)—or —SO₂—; and

(iii) xanthene having at least two phenolic hydroxyl groups;

and the monovalent groups (i) to (iii) may optionally have additional substituents in addition to the hydroxyl groups; and

Ar′ is selected from the following divalent groups (iv) to (vi):

(iv) a monocyclic ring having at least two phenolic hydroxyl groups and a fused C₆-C₁₈ polycyclic arylene group;

(v) a divalent group having at least two phenolic hydroxyl groups and formed by two phenyl groups or naphthyl groups via chemical bonding or a linkage group, wherein the linkage group is selected from an optionally substituted C₁-C₆ alkylene, an optionally substituted C₁-C₆ cyclic alkylene, —O—, —S—, —S—S—, —C(═O)— or —SO₂—; and

(vi) xanthene having at least two phenolic hydroxyl groups;

and the divalent groups (i) to (iii) may have additional substituents in addition to the hydroxyl groups.

The flame resistant resin composition of the invention has an epoxy resin having a biphenylic unit or a napthalenic unit, and a phenolic resin having a biphenylic unit and a polyphenolic unit as a curing agent, such that excellent flame resistance can be achieved without adding flame resistant agents. The resin composition of the invention also has a higher glass transition temperature, which can increase heat stability and improve the water absorption issue after curing. Therefore, the invention is particularly useful in composite materials, forming materials or semiconductor packaging materials.

### DETAILED DESCRIPTION OF THE PREFERRED EMBODIMENTS

The flame resistant resin composition of the invention comprises (A) at least one epoxy resin having a biphenylic unit or a naphthalenic unit; (B) phenolic resins used as curing agents, and comprising a least a phenolic resin having a biphenylic moiety and a polyphenolic moiety, wherein the phenolic resin having a biphenylic moiety and a polyphenolic moiety is in an amount of 30 to 100 wt % of the total weight of the phenolic resins; (C) a curing-promoting agent; and (D) an inorganic filler material.

In a preferred embodiment of the invention, the number ratio (C/O) of the carbon atoms to the oxygen (O) atoms in the biphenylic and polyphenolic moieties of the phenolic resin is smaller than (26+20n)/(n+2).

In another preferred embodiment of the invention, the phenolic resin having the biphenylic and the polyphenolic moieties has the structure represented by formula (I):

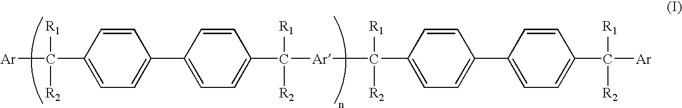

wherein,

R₁ and R₂ are the same or different, and R₁ and R₂ are independently hydrogen or a C₁-C₆ alkyl group; n is 0 or an integer of 1 to 10;

Ar is a selected from the following monovalent groups (i) to (iii):

(i) a monocyclic ring having at least two phenolic hydroxyl groups and a fused C₆-C₁₈ polycyclic aryl group;

(ii) a monovalent group having at least two phenolic hydroxyl groups and formed by two phenyl groups or naphthyl groups via chemical bonding or a linkage group, wherein the linkage group is selected from an optionally substituted C₁-C₆ alkylene, an optionally substituted C₁-C₆ cyclic alkylene, —O—, —S—, —S—S—, —C(═O)— or —SO₂—; and

(iii) xanthene having at least two phenolic hydroxyl groups; and the monovalent groups (i) to (iii) may optionally have other substituents in addition to the hydroxyl groups; and

Ar′ is selected from the following divalent groups (iv) to (vi):

(iv) a monocyclic ring having at least two phenolic hydroxyl groups and a fused C₆-C₁₈ polycyclic arylene group;

(v) a divalent group having at least two phenolic hydroxyl groups and formed by two phenyl groups or naphthyl groups via chemical bonding or a linkage group, wherein the linkage group is selected from an optionally substituted C₁-C₆ alkylene, an optionally substituted C₁-C₆ cyclic alkylene, —O—, —S—, —S—S—, —C(═O)— or —SO₂—; or

(vi) xanthene having at least two phenolic hydroxyl groups; and the divalent groups (i) to (iii) may have additional substituents in addition to the hydroxyl groups.

In the above definition of Ar, the monovalent group (i) includes, but not limited to, a monovalent group having two phenolic hydroxyl groups and selected from group consisting of a phenyl group, a naphthyl group, an anthryl group and a phenanthryl group. The monovalent group has two phenolic hydroxyl groups, and is further optionally substituted by 1 to 4 substituents independently selected from the group consisting of a phenyl group, a C₁-C₆ alkyl group, a ketone group, a nitro group, a carboxyl group and a sulfo group.

Examples of the monovalent group (i) include, but not limited to:

dihydroxyphenyls such as 1,3-dihydroxyphenyl or 2-phenyl-1,4-dihydroxyphenyl(2-phenylhydroquinone);

dihydroxynaphthyls such as 1,2-dihydroxynaphthyl, 1,3-dihydroxynaphthyl, 1,4-dihydroxynaphthyl, 1,5-dihydroxynaphthyl, 1,6-dihydroxynaphthyl, 1,7-dihydroxynaphthyl, 1,8-dihydroxynaphthyl, 2,3 -dihydroxynaphthyl, 2,6-dihydroxynaphthyl, 2,7-dihydroxynaphthyl and 2-methyl-1,4-dihydroxynaphthyl;

a monovalent group formed by removing a hydrogen atom is removed from the anthryl moiety of any one of the following compounds: 1,5-dihydroxyanthracene, 3,4-dihydroxyanthrone, 1,8-dihydroxy-3-methylanthrone, 1,2-dihydroxy-3-nitroanthraquinone, 1,8-dihydroxy-2,4,5,7-tetranitroanthraquinone, 5,6-dihydroxyanthraquinone-2-formic acid and 3,4-dihydroxyanthraquinone-2-sulfonic acid; and

dihydroxyphenanthryls such as 1,2-dihydroxyphenanthryl, 1,4-dihydroxyphenanthryl, 1,5-dihydroxyphenanthryl, 1,6-dihydroxyphenanthryl, 1,7-dihydroxyphenanthryl, 2,3-dihydroxyphenanthryl, 2,5-dihydroxyphenanthryl, 2,6-dihydroxyphenanthryl, 2,7-dihydroxyphenanthryl, 3,4-dihydroxyphenanthryl, 3,6-dihydroxyphenanthryl, 3,10-dihydroxyphenanthryl and 9,10-dihydroxyphenanthryl.

In the above definition of Ar, the monovalent group (ii) includes the group represented by formula (II):

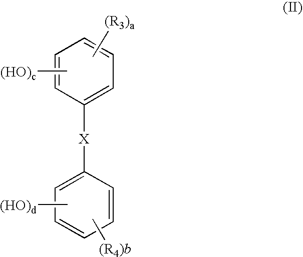

wherein,

X is a chemical bond, or a linkage group selected from a C₁-C₆ alkylene optionally substituted with a phenyl group, a C₁-C₄ alkylphenyl group or a carboxyl group, a C₅-C₆ cyclic alkylene optionally substituted with a C₁-C₄ alkyl group and a linkage group of —O—, —S—, —C(═O)— or —SO₂—,

R₃ and R₄ are independently H, a C₁-C₆ alkyl group or a C₁-C₆ alkoxyl group, one of a and b is 0, and the other one is an integer of 1 to 4,

c+d is an integer of 2 to 4, and

the constraint is a+c≦5 and b+d≦5.

Examples of X in the monovalent group (ii) represented by formula (II) includes, but not limited to, 2,2′-dihydroxybiphenyl, 4,4′-dihydroxybiphenyl and 3,3′,5,5′-tetramethoxy-4,4′-dihydroxybiphenyl.

Examples of X in the monovalent group (ii) represented by formula (II) as a linkage group include, but not limited to, a monovalent group formed by removing a phenyl group removed from any one the following compounds: 4,4′-dihydroxydiphenyl ether, bis(4-hydroxy-2-methylphenyl)ether, bis(4-hydroxyphenyl)thioether, bis(4-hydroxyphenyl), bis(4-hydroxyphenyl)ketone, bis(4-hydroxyphenyl)methane, bis(4-hydroxy-3-methylphenyl)methane, 1,1-bis(4′hydroxyphenyl)ethane, 2,2-bis(4′-hydroxyphenyl)propane, 2,2-bis(4′-hydroxy-3′-methylphenyl)propane, 1,1-bis(4′hydroxyphenyl)butane, 1,1-bis(4′hydroxyphenyl)phenylmethane, bis(4′hydroxyphenyl)diphenylmethane, bis(4-hydroxyphenyl)4′-methylphenylmethane, 1,1-bis(4′hydroxyphenyl)cyclohexane, bis(4′-hyroxyphenyl)methylcyclohexane, bis(4′-hydroxy-3,5-dimethylphenyl)methane, bis(4′-hydroxy-3,5-dimethylphenyl)ketone, bis(3-hydroxyphenyl)thioether, bis(3-hydroxyphenyl), bis(3-hydroxyphenyl)ether, 3-hydroxyphenyl-4′-hydroxyphenyl ether and 3,4-bis(4′hydroxyphenyl)hexane.

In the above definition of Ar, the monovalent group (ii) also includes, but not limited to, a monovalent group formed by removing a hydrogen atom from the naphthyl moiety of any one of the following compounds: 2,2′-dihydroxy-1,1′-binaphthyl, 2,2-bis(4′hydroxynaphthyl)propane and 1,1′-disulfo-2-naphthol.

In the above definition of Ar, the monovalent group (iii) includes, but not limited to, a monovalent group formed by removing a hydrogen atom removed from the xanthene moiety of any one of the following compounds: 1,3-dihydroxy xanthone and 2,7-dihydroxy-9-phenyl xanthene.

The term “C₁-C₆ alkyl group” used herein refers to a straight or branched monovalent alkoxy group having 1 to 6 carbon atoms, and the monovalent alkoxy group particularly includes, but not limited to, a methyl group, an ethyl group, a propyl group, an iso-propyl group, a butyl group, a sec-butyl group, a tert-butyl group, a pentyl group, a hexyl group and isomeric groups thereof.

The term “C₁-C₆ alkoxy group” used herein refers to a straight or a branched monovalent alkyl group having 1 to 6 carbon atoms, and the monovalent alkyl group particularly includes, but not limited to, a methoxy group, an ethoxy group, a propoxy group, an iso-propoxy group, a butoxy group, a sec-butoxy group, a tert-butoxy group, a pentoxy group, a hexyloxy group and isomeric groups thereof.

The term “C₁-C₆ alkylene” used herein refers to a straight or a branched divalent alkyl group having 1 to 6 carbon atoms, and the divalent alkyl group particularly includes, but not limited to, methylene, ethylene, iso-propylene, butylene, sec-butylene, pentylene and hexylene.

The term “C₅-C₆ cycloalkylene” used herein refers to a divalent cycloalkyl group having 5 or 6 carbon atoms, and the divalent cycloalkyl group includes, but not limited to, cyclopentylene or cyclohexylene.

In the flame resistant resin composition of the invention, the curing agent (B) can further includes other types of epoxy resins as curing agents such as novolak resins or cresol resins, in addition to the employment of a phenolic resin having a biphenylic moiety and a polyphenolic moiety. If the amount of the above-mentioned phenolic resin is less than 30 wt % of the total weight of phenolic resins when various phenolic resins are used as curing agents, it will be detrimental to flame resistance of the resin composition. Therefore, in the flame resistant resin composition of the invention, the above-mentioned phenolic resin having a biphenylic moiety and a polyphenolic moiety is preferably in an amount of 30 to 100 wt % of the total weight of the phenolic resins of the composition.

In an embodiment, the resin composition of the invention uses the epoxy resin having a biphenylic unit represented by formula (III) as the epoxy resin for the ingredient (A):

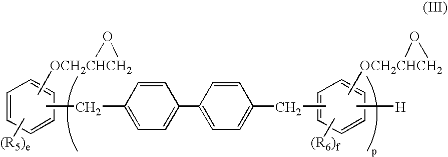

wherein R₅ and R₆ are independently a C₁-C₆ alkyl group; e is 0 or an integer of 1 to 4; f is 0 or an integer of 1 to 3; and p is an integer of 1 to 10.

In another embodiment, the resin composition of the invention uses the epoxy resin having a naphthalene unit represented by formula (IV) as the epoxy resin for the ingredient (A):

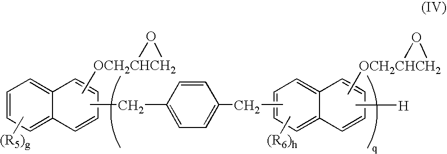

wherein R₅ and R₆ are independently a C₁-C₆ alkyl group; g is 0 or an integer of 1 to 6; h is 0 or an integer of 1 to 5; and q is an integer of 1 to 10.

In the flame resistant resin composition of the invention, that the content ratio of the epoxy resin of the ingredient (A) to the curing agent of the ingredient (B), based on the ratios of the epoxy equivalent of the epoxy resin and the active hydrogen equivalent of the hardening agent, is preferably in the range of 1:0.4 to 1:2.5, more preferably in the range of 1:0.5 to 1:2.0, and even more preferably in the range of 1:0.6 to 1:1.6.

In the resin composition, the curing-promoting agent of ingredient (C) is mainly used as an ingredient for promoting curing reactions between the epoxy group of the epoxy resin and the active hydrogen functional group (such as a phenolic hydroxyl group) of the curing agent. The curing promoting agent particularly includes, but not limited to, tertiary amine compounds such as triethylamine, benzyldimethylamine and α-methylbenzyl-dimethylamine; tertiary phosphine compounds such as triphenylphosphine, tributylphosphine, tri(p-methylphenyl)phosphine and tri(nonylphenyl)phosphine; quaternary ammonium salts such as tetramethylammonium chloride, tetraethylammonium bromide, tetrabutylammonium iodide, triethylbenzylammonium chloride, triethylbenzylammonium bromide and triethylphenethylammonium iodide; quaternary phosphonium salts such as tetrabutylphosphonium chloride, tetraphenylphosphonium bromide, ethyltriphenylphosphonium chloride, propyltriphenylphosphonium bromide, butyltriphenylphosphonium iodide, tetrabutylphosphonium acetate and ethyltriphenylphosphonium phosphate; and imidazole compounds such as 2-methylimidazole, 2-heptadecaneimidazole, 2-phenylimidazole, 4-ethylimidazole, 4-dihexylimidazole, 2-phenyl-4-hydroxymethylimidazole, 2-ethyl-4-hydroxymethyl imidazole, 1-cyanoethyl-4-methylimidazole and 2-phenyl-4,5-dihydroxymethylimidazole. These curing-promoting agents may be used alone or in combination with two or more curing-promoting agents as a mixture. Preferably, imidazole compounds and tertiary phosphine compounds (particularly 2-methylimidazole, 2-phenylimidazole, triphenylphosphine or a mixture thereof) are used.

The curing-promoting agent exists in an amount sufficient to effectively promote curing of resins. Generally speaking, the curing-promoting agent of the ingredient (C) preferably comprises and amount of 0.01 to 5.0 wt %, more preferably comprises an amount of 0.02 to 3.9 wt %, and even more preferably comprises 0.05 to 2.0 wt %, of the total weight of the resin composition. If the amount of the curing promoting-agent is insufficient, the desired curability cannot be obtained. On the contrary, if the amount of the curing-promoting agent is too high, the mobility of the resin composition would be adversely affected.

In the resin composition, the inorganic filler material of ingredient (D) is mainly used for adjusting various properties of the resin composition, such as conductivity; wear resistance; thermal expansion coefficient; tensile strength; thermal conductivity; water resistance; and drug resistance. Particular examples of the inorganic filler material include, but not limited to, silicon dioxide powder such as globular-type molten silicon dioxide and angular-type molten silicon dioxide; quartz glass powder; talc powder; aluminum oxide powder; and calcium carbonate powder. The type and the quantity of the inorganic filler material are not particularly limited, as long as they will not adversely affect the resin composition. Generally speaking, the inorganic filler material of the ingredient (D) preferably comprises 50 to 95 wt %, more preferably comprises 70 to 90 wt %, and even more preferably comprises 80 to 85 wt %, of the total weight of the resin composition.

In the flame resistant resin composition of the invention, an additive may be optionally contained. The type of the additive is not particularly limited, but preferably the one not reacting with the epoxy resin or the curing agent. Particular examples of the additive include coloring agents such as carbon black; coupling agents such as γ-glycidoxypropyltrimethoxysilane; leavening agents such as paraffin, long-chain fatty acids or metal salts thereof; and anti-oxidants.

The flame resistant resin composition of the invention uses an epoxy resin having a biphenylic unit or a naphthalenic unit, in combination with phenolic resins having a biphenyl moiety and a polyphenolic moiety, as a curing agent to achieve excellent flame resistance without adding flame resistant agents. The flame resistant resin composition also has a higher glass transition temperature, which could improve the water absorption issue after curing, and increases heat stability. Therefore, the flame resistant resin composition of the invention is useful in composite materials, forming materials or semiconductor packaging materials.

### EXAMPLES

Characteristics and effects of the invention are further illustrated by the examples below.

The ingredients used in the examples are illustrated below in details:

Epoxy resin 1—the epoxy resin having a naphthalenic unit represented by formula (V), with an epoxy equivalent of 270 g/eq.

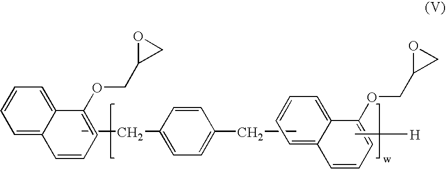

(wherein w=1 to 10)

Epoxy resin 2—a polyglycidyl ether of cresol-aldehyde condensates manufactured by Chang Chun Group under the product name CNE200, with an epoxy equivalent of between 200 to 220 g/eq.

Epoxy resin 3—a epoxy resin having a biphenylic unit manufactured by Nippon Kayaku K. K. under the product name NC3000P, with an epoxy equivalent of 278 g/eq.

Epoxy resin 4—a diglycidyl ether of tetrabromobisphenol A manufactured by Chang Chun Group under the product name BEB530A80, and the epoxy equivalent is between 430 to 450 g/eq and a bromide content of between 18.5 to 20.5 wt %.

Curing agent 1—the phenolic resin curing agent having a biphenylic moiety and a polyphenolic moiety represented by formula (VI), with an active hydrogen equivalent of 155 g/eq.

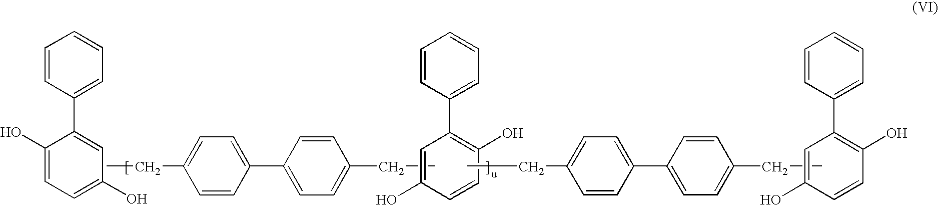

(wherein u=0 to 10)

Curing agent 2—the phenolic resin curing agent having a biphenylic moiety and a polyphenolic moiety represented by formula (VII), with an active hydrogen equivalent of 115 g/eq.

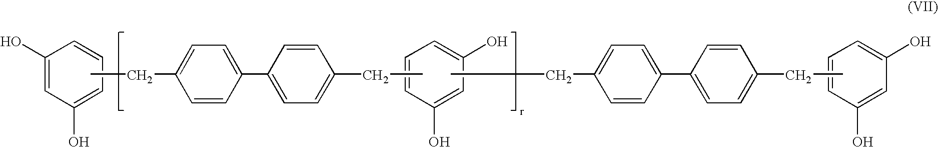

(wherein r=0 to 10)

Curing agent 3—a novolak resin manufactured by Chang Chun Group under the product name PF5080 represented by formula (VIII), with an active hydrogen equivalent of between 105 to 110 g/eq.

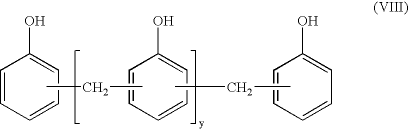

(wherein y=0 to 10)

Curing agent 4—a phenolic resin manufactured by MeiwaChemicals K. K. under the product name MEH-7851SS represented by formula (IX), with an active hydrogen equivalent of 203 g/eq.

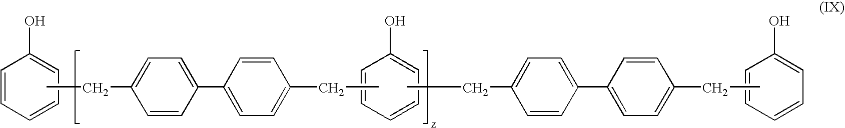

(wherein z=0 to 10)

Catalyst (Curing-promoting agent)—triphenyl phosphine

Analytic methods are discussed below.

### (1) Glass Transition Temperature:

A thermal mechanical analysis apparatus was used for measuring the glass transition temperature at an increasing rate of 5° C./min.

### (2) Flame Resistance:

Strips with a length of 5 inches, a width of 0.5 inch and a thickness of 1/16 inch were used to test for heat resistance in accordance with the UL 94 flammability rating.

### (3) Hydroscopicity:

Circular strips with a diameter of 25 mm and a thickness of 5 mm were used to test for increase in the weight of water absorption, after boiling for 24 hours in 100° C. boiling water.

### (4) Heat Stability in a 288° C. Tin Furnace:

Strips with a length of 5 inches, a width of 0.5 inch and a thickness of 1/16 inch were inserted into the 288° C. tin furnace for 30 seconds, and the strips were observed for occurrence of bubbling or cracking.

### Examples 1 to 5 and Comparative Examples 1 to 3

The ingredients were thoroughly mixed in the room temperature in the amounts listed in Table 1. The mixture was mixed at 70 to 110° C. by a pair of rollers, and then the mixture was cooled down for pulverization to obtain the epoxy resin composition powder. The glass transition temperature, the flame resistance, the hydroscopicity and the heat resistance of each sample were analyzed, and the results are listed in Table 1.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Epoxy resin 1 | 8.9 | | | 10 | | | | |
| Epoxy resin 2 | | | | | | | | 16.0 |
| Epoxy resin 3 | | 9 | 10 | | 10.2 | 8.1 | 10 | |
| Epoxy resin 4 | | | | | | | | 3.0 |
| Curing agent 1 | 5.1 | 5 | 1.2 | 1.2 | | | 1 | |
| Curing agent 2 | | | | | 1.2 | | | |
| Curing agent 3 | | | 2.8 | 2.8 | 2.6 | | 3 | 9 |
| Curing agent 4 | | | | | | 5.9 | | |
| Triphenylphosphino | 0.15 | 0.15 | 0.15 | 0.15 | 0.15 | 0.15 | 0.15 | 0.15 |
| Molten Silicon | 84 | 84 | 84 | 84 | 84 | 84 | 84 | 70 |
| dioxide | | | | | | | | |
| Releasing agent | 1 | 1 | 1 | 1 | 1 | 1 | 1 | 1 |
| Coupling agent | 0.65 | 0.65 | 0.65 | 0.65 | 0.65 | 0.65 | 0.65 | 0.65 |
| Carbon black | 0.2 | 0.2 | 0.2 | 0.2 | 0.2 | 0.2 | 0.2 | 0.2 |
| Total amount | 100 | 100 | 100 | 100 | 100 | 100 | 100 | 100 |
| Equivalent ratio*¹ | 1.00 | 1.00 | 1.05 | 1.08 | 1.08 | 1.00 | 1.03 | 1.03 |
| Tg(° C.) | 156 | 154 | 158 | 158 | 158 | 141 | 156 | 161 |
| Flame resistance | Pass | Pass | Pass | Pass | Pass | Pass | Fail | Pass |
| UL-94 V-0 | | | | | | | | |
| Hydroscopicity | 0.18 | 0.17 | 0.2 | 0.2 | 0.2 | 0.16 | 0.2 | 0.27 |
| Heat stabitity of a | ∘ | ∘ | ∘ | ∘ | ∘ | ∘ | ∘ | Δ |
| 288° C. Fin Furnace*² | | | | | | | | |

*¹Equivalent ratio: the ratio of the epoxy equivalent of the epoxy resin to the active hydrogen equivalent of the curing agent.
*²∘: Excellent Δ: Poor

The results in Table 1 indicate that when the inorganic filler material was 84 wt %, the flame resistance of the flame resistant resin composition of the invention met the UL 94V-0 standard.

According to the result of Comparative Example 2, the test sample of the resin composition failed to pass the UL 94 flammability test when the amount of the phenolic resin having a biphenylic moiety and a polyphenolic moiety represented by formula (I) was in an amount of less than 30 wt % of the total weight of the phenolic resins.

By comparing Example 2 with Comparative Example 1, it appeared that the use of the phenolic resin represented by formula (I) as a curing agent in the flame resistance resin composition of the invention had a higher glass transition temperature after curing, because the molecules in the biphenylic and the polyphenolic units have more phenolic hydroxyl groups for cross-linking. On the contrary, the biphenylic moiety, and possibly the naphthalenic moiety too, of the phenolic resin contained in the resin composition of the invention can improve the water absorption issue after curing of the curing agent having multiple functional groups.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A flame resistant resin composition, comprising:
(A) at least an epoxy resin having a biphenylic unit or a naphthalenic unit;
(B) phenolic resins being used as a curing agent, and having at least a phenolic resin comprising a biphenylic moiety and a polyphenolic moiety, wherein the at least a phenolic resin comprising a biphenylic moiety and a polyphenolic moiety in an amount of 30 to 100 wt % of the total weight of the phenolic resins in the composition;
(C) a curing-promoting agent; and
(D) an inorganic filler material.

2. The composition of claim 1, wherein the at least a phenolic resin comprising a biphenylic moiety and a polyphenolic moiety is represented by formula (I) shown below: 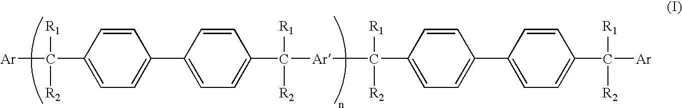
wherein R₁ and R₂ are the same or different, and R₁ and R₂ are independently hydrogen or a C₁-C₆ alkyl group; n is 0 or an integer of 1 to 10; Ar is selected from group consisting of the monovalent groups (i) to (iii) as follows:
(i) a monocyclic ring having at least two phenolic hydroxyl groups and a fused C₆-C₁₈ polycyclic aryl group;
(ii) a monovalent group having at least two phenolic hydroxyl groups and formed by two phenyl groups or naphthyl groups via chemical bonding or a linkage group, wherein the linkage group is selected from the group consisting of an optionally substituted C₁-C₆ alkylene, an optionally substituted C₂-C₆ cyclic alkylene, —O—, —S—, —S—S—, —C(═O)—, and —SO₂—; and
(iii) xanthene having at least two phenolic hydroxyl groups; and the monovalent groups (i) to (iii) optionally have additional substituents in addition to the hydroxyl groups; and
Ar′ is selected from the group consisting of divalent groups (iv) to (vi) as follows:
(iv) a monocyclic ring having at least two phenolic hydroxyl groups and a fused C₆-C₁₈ polycyclic arylene group;
(v) a divalent group having at least two phenolic hydroxyl groups and formed by two phenyl groups or naphthyl groups via chemical bonding or a linkage group, wherein the linkage group is selected from the group consisting of an optionally substituted C₁-C₆ alkylene, an optionally substituted C₁-C₆ cyclic alkylene, —O—, —S—, —S—S—, —C(═O)—, and —SO₂—; and
(vi) xanthene having at least two phenolic hydroxyl groups; and the divalent groups (iv) to (vi) may optionally have additional substituents in addition to hydroxyl groups.

3. The composition of claim 2, wherein the number ratio (C/O) of the carbon (C) atoms to the oxygen (O) atoms is smaller than (26+20n)/(n+2).

4. The composition of claim 2, wherein Ar is a monovalent group selected from the group consisting of a phenyl group, a naphthyl group, an anthryl group and a phenanthryl group, wherein the monovalent group has two phenolic hydroxyl groups, and is optionally substituted with 1 to 4 substituents independently selected from the group consisting of a phenyl group, a C₁-C₆ alkyl group, a ketone group, a nitro group, a carboxyl group and a sulfo group.

5. The composition of claim 2, wherein Ar is the monovalent group represented by formula (II): 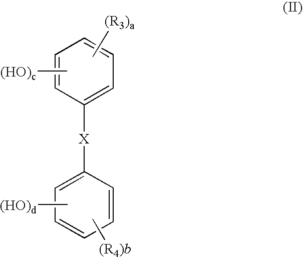
wherein X is a chemical bond or a C₁-C₆ alkylene optionally substituted with a phenyl group, a C₁-C₄ alkylphenyl group or a carboxyl group, a C₅-C₆ alkylene optionally substituted with a C₁-C₄ alkyl group, linkage groups of —O—, —S—, —C(═O)— or SO₂, R₃ and R₄ is independently H, a C₁-C₆ alkyl group or a C₁-C₆ alkoxy group, one of a and b is 0, while the other one is an integer of 1 to 4, c+d is an integer of 2 to 4, and the a, b, c and d satisfy the following relation: a+c≦5 and b+d≦5.

6. The composition of claim 1, wherein the epoxy resin of (A) has a biphenylic unit, and is of a structure represented by formula (III): 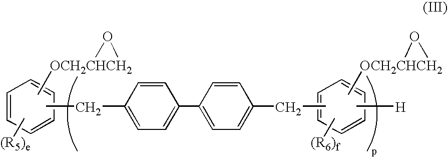
wherein R₅ and R₆ is independently C₁-C₆ alkyl groups; e is 0 or an integer of 1 to 4; f is 0 or an integer of 1 to 3; and p is an integer of 1 to 10.

7. The composition of claim 1, wherein the epoxy resin of (A) has a naphthalenic unit and is of the structure represented by formula (IV): 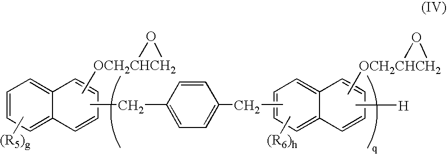
wherein R₅ and R₆ is independently C₁-C₆ alkyl groups; g is 0 or an integer of 1 to 6; h is 0 or an integer of 1 to 5; and q is an integer of 1 to 10.

8. The composition of claim 1, wherein the amount ratio of the epoxy resin of (A) to the curing agents of (B) is 1:0.4 to 1:2.5 based on the ratio of an epoxy equivalent of the epoxy resin to an active hydrogen equivalent of the curing agent.

9. The composition of claim 1, wherein the curing-promoting agent of (C) is selected from the group consisting of a tertiary amine, a tertiary phosphine, a quaternary ammonium salt, a quaternary phosphonium salt and an imidazole compound.

10. The composition of claim 1, wherein the inorganic filler material of (D) is selected from the group consisting of silicon dioxide powder, quartz glass powder, talc powder, aluminum oxide powder and calcium carbonate powder.
